(19) United States
(12) Patent Application Publication
(10) Pub. No.: US 2015/0154610 A1
(43) Pub. Date: Jun. 4, 2015

(54) DETECTING POTENTIALLY FALSE BUSINESS LISTINGS BASED ON AN ANOMALY DETECTION THRESHOLD

(71) Applicants: Yi- An Huang, Fremont, CA (US); Baris Yuksel, New York, NY (US)

(72) Inventors: Yi- An Huang, Fremont, CA (US); Baris Yuksel, New York, NY (US)

(73) Assignee: GOOGLE INC., Mountain View, CA (US)

(21) Appl. No.: 13/168,291

(22) Filed: Jun. 24, 2011

Related U.S. Application Data
(60) Provisional application No. 61/485,846, filed on May 13, 2011.

(51) Int. Cl. G06Q 30/00; G06Q 99/00

(52) U.S. Cl. CPC G06Q 30/0185

(57) ABSTRACT

An apparatus for detecting potentially false business listings is provided. The apparatus may include a memory that stores a plurality of business listings and a plurality of corresponding impression values for the business listings. The apparatus may also include a processor operative to provide one or more business listings to one or more client devices during a first time period. During the first time period, the processor may determine one or more impression values for the provided one or more business listings. Based on one or more of these impression values, the processor may further determine an anomaly detection threshold. The processor may then compare the anomaly detection threshold with one or more impression values stored during a second time period in which the one or more business listings were requested. Based on this comparison, the processor may identify potentially false business listings in the plurality of business listings.

### CROSS-REFERENCE TO RELATED APPLICATIONS

This application claims the benefit of priority to U.S. Provisional Patent Application No. 61/485,846, entitled “DETECTING POTENTIALLY FALSE BUSINESS LISTINGS BASED ON AN ANOMALY DETECTION THRESHOLD” and filed May 13, 2011, the entire disclosure of which is incorporated herein by reference.

### BACKGROUND

A user with a business may enroll with an Internet service provider, an Internet search provider, or other entity to provide information about the user's business to other Internet users. The user may establish a business listing with the Internet search provider such that when other Internet users conduct a search with the Internet search provider, the business listing of the user may appear as a result provided to the inquiring user.

In general, when a business listing is provided to a user, the Internet search provider may record the provision of the business listing as an “impression.” Depending on the popularity of the business, a business listing may receive hundreds or thousands of impressions during a given time period, such as one day. However, other business listings may receive fewer impressions, sometimes in the single-digits.

To increase the importance or relevance of a business listing with a low number of impressions, the owner of the business listing may employ various spamming techniques. For example, the owner may create dozens, or even hundreds of identical business listings for his or her one business, each of which have fake locations. These fake business listings, called “spam business listings,” may have differences between each other, such as different addresses, different homepages, different phone numbers, or other differences.

Moreover, these fake phone numbers and fake homepages may forward to the single owner's real phone number or real homepage. As an example, a business owner may create 100 business listings, and for each of these listings, the business owner may list the address of each intersection of Manhattan. When a person calls the phone numbers listed on the fake business listings, the call may be forwarded to the real phone number. Hence, even though it appears that there are 100 different businesses, there is, in fact, only one. This “map spam” is problematic because it tricks or dupes a user searching for a business into believing that there are many different businesses. In addition, the user may be tricked into believing that the business is closer to the user than some other business, such as a competitor.

### BRIEF SUMMARY

An apparatus for detecting potentially false business listings is disclosed. In one embodiment, the apparatus includes a processor operative to access, from a computer-readable medium, an anomaly detection threshold for a common business. The anomaly detection threshold may be determined from a plurality of impression values for a plurality of business listings associated with the common business during a first time period in which one or more business listings for the common business were requested. The processor may be further operative to compare the anomaly detection threshold with one or more impression values from a second time period in which one or more business listings for the common business were requested. Moreover, when the one or more impression values from the second time period exceeds the anomaly detection threshold, the processor may identify the common business as having potentially false business listings in the plurality of business listings.

In another embodiment of the apparatus, the processor is operative to determine the anomaly detection threshold as two standard deviations above an average number of impressions for the plurality of business listings.

In a further embodiment of the apparatus, the processor is further operative to provide the one or more business listings to a client device when the processor receives a request for the one or more business listings from the client device.

In yet another embodiment of the apparatus the plurality of business listings are associated with the common business when each of the business listings of the plurality of business listings have the substantial same business listing attribute value for a business listing attribute.

In yet a further embodiment of the apparatus, a business listing of the plurality of business listings includes a business listing phone number and an impression value from the one or more impression values from the second time period is based on a number of times the business listing phone number was provided to a client device during the second time period.

In another embodiment of the apparatus a business listing of the plurality of business listings is associated with a web site and an impression value from the one or more impression values from the second time period is based on a number of times the web site associated with the business listing was provided to a client device client device during the second time period.

In a further embodiment of the apparatus, a business listing of the plurality of business listings includes a business listing title and an impression value from the one or more impression values from the second time period is based on a number of times the business listing title was provided to a client device during the second time period.

In yet another embodiment of the apparatus, a business listing of the plurality of business listings includes a business listing title and a business listing phone number. The business listing may also be associated with a web site. In addition, an impression value from the one or more impression values from the second time period may be based on the number of times any of the business listing title, the business listing phone number, and the web site was provided to a client device.

In yet a further embodiment of the apparatus, the first time period is segmented into one or more time segments including one or more days, and an impression value from the one or more impression values from the first time period is based on the number of times the business listing was provided to a client device during a selected time segment from the first time period.

In another embodiment of the apparatus, the first time period is a longer time period than the second time period.

In a further embodiment of the apparatus, the first time period is segmented into one or more time segments, and the second time period includes a selected time segment from the first time period.

In yet another embodiment of the apparatus, the first time period is segmented into one or more time segments, and the anomaly detection threshold is determined from a standard deviation of selected impression values from a selected plurality of time segments from the first time period.

In yet a further embodiment of the apparatus, the processor is further operative to request verification that the identified common business has the one or more potentially false business listings.

A method for detecting potentially false business listings is also disclosed. In one embodiment, the method includes accessing, from a computer-readable medium, an anomaly detection threshold for a common business, the anomaly detection threshold determined from a plurality of impression values for a plurality of business listings associated with the common business during a first time period in which one or more business listings for the common business were requested. The method may also include comparing, with a processor, the anomaly detection threshold with one or more impression values from a second time period in which one or more business listings for the common business were requested. Moreover, when the one or more impression values from the second time period exceeds the anomaly detection threshold, the method may provide identifying the common business as having potentially false business.

In another embodiment of the method, the method may include determining the anomaly detection threshold as two standard deviations above an average number of impressions for the plurality of business listings.

In a further embodiment of the method, the method may include providing the one or more business listings to a client device when a request is received for the one or more business listings from the client device.

In yet another embodiment of the method, the plurality of business listings are associated with the common business when each of the business listings of the plurality of business listings have the substantial same business listing attribute value for a business listing attribute.

In yet a further embodiment of the method, a business listing of the plurality of business listings comprises a business listing phone number and an impression value from the one or more impression values from the second time period is based on a number of times the business listing phone number was provided to a client device during the second time period.

In another embodiment of the method, a business listing of the plurality of business listings is associated with a web site and an impression value from the one or more impression values from the second time period is based on a number of times the web site associated with the business listing was provided to a client device client device during the second time period.

In a further embodiment of the method, a business listing of the plurality of business listings comprises a business listing title and an impression value from the one or more impression values from the second time period is based on a number of times the business listing title was provided to a client device during the second time period.

In yet another embodiment of the method, a business listing of the plurality of business listings comprises a business listing title and a business listing phone number, and the business listing is associated with a web site. Moreover, an impression value from the one or more impression values from the second time period is based on the number of times any of the business listing title, the business listing phone number, and the web site was provided to a client device.

In yet a further embodiment of the method, the first time period is segmented into one or more time segments comprising one or more days, and an impression value from the one or more impression values from the first time period is based on the number of times the business listing was provided to a client device during a selected time segment from the first time period.

In another embodiment of the method, the first time period is a longer time period than the second time period.

In a further embodiment of the method, the first time period is segmented into one or more time segments, and the second time period comprises a selected time segment from the first time period.

In yet another embodiment of the method, the first time period is segmented into one or more time segments, and the anomaly detection threshold is determined from a standard deviation of selected impression values from a selected plurality of time segments from the first time period.

In yet a further embodiment of the method, the method includes requesting verification that the identified common business has the one or more potentially false business listings.

Another apparatus for detecting potentially false business listings is also disclosed. In one embodiment, the apparatus includes a memory operative to store a plurality of business listings, wherein each business listing is associated with a common business, and a plurality of impression values that identify a number of times a corresponding business listing was provided to one or more client devices. The apparatus may also include a processor in communication with the memory, the processor being operative to, for a first time period, store one or more impression values determined according to whether one or more of the business listings from the plurality of business listings were provided to one or more client devices during the first time period. The processor may also determine a standard deviation for the one or more impressions values stored during the first time period.

Moreover, the processor may compare the standard deviation for the one or more impression values with one or more impression values for the one or more the business listings stored during a second time period, and when the one or more impression values stored during the second time period exceeds the determined standard deviation, identify that the common business has one or more potentially false business listings.

### BRIEF DESCRIPTION OF THE DRAWINGS

FIG. 1 illustrates one example of an apparatus for detecting potentially false business listings according to aspects of the invention.

FIG. 2 illustrates one example of a business listing server according to aspects of the invention.

FIG. 3 illustrates one example of determining an anomaly detection threshold to aspects of the invention.

FIG. 4 illustrates one example of logic flow for detecting potentially false business listings according to aspects of the invention.

### DETAILED DESCRIPTION

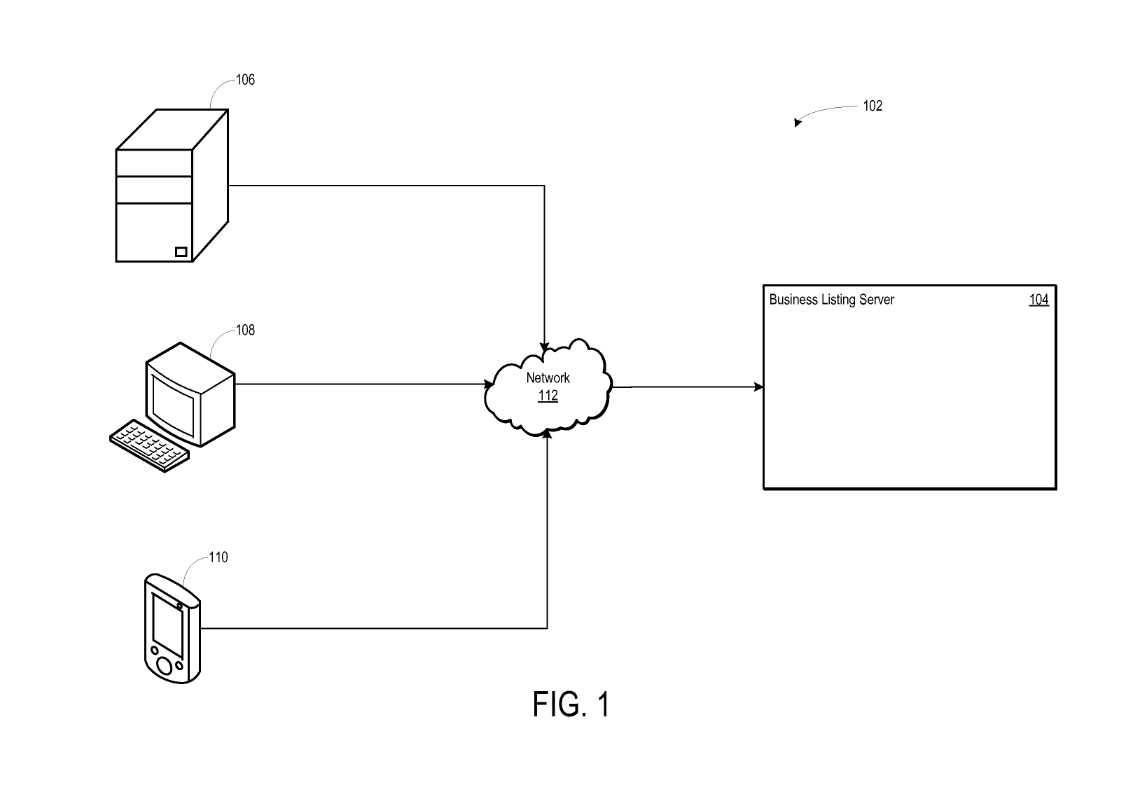

FIG. 1 illustrates one example of an apparatus 102 for detecting potentially false business listings. In one embodiment, the apparatus 102 may include a business listing server 104 in communication with client devices 106-110 via a network 112.

The client devices 106-110 may comprise many different types of client devices, such as an Internet search provider 106 operative to provide one or more search results that may include a business listing provided by the business listing server 104. Where the client device 106 is an Internet search provider, the business listing server 104 may provide one or more business listings to the Internet search provider 106 in response to requests for those business listings. For example, the Internet search provider 106 may receive a search query from a user, and the Internet search provider 106 may communicate with the business listing server 104 to include one or more business listings in the search results that the Internet search provider 106 may provide to the user.

The client device 106 may also be a social network provider or a local search provider that communicates with the business listing server 104 to provide one or more business listings in response to queries that the client device 106 may receive from one or more users.

The client device 106 may alternatively be a map service provider or navigation assistance provider, where the information for one or more points of interest presented on a map provided by the client device 106 is based on one or more business listings provided by the business listing server 104. In other words, the client device 106 may be any system or other provider that communicates with the business listing server 104 to retrieve and/or request one or more business listings.

In an alternative embodiment, the business listing server 104 may also comprise an Internet search provider that provides one or more business listings to one or more end users, such as users using client devices 108-110. Moreover, the business listing server 104 may comprise any one or more of the aforementioned systems for providing business information to one or more end users, such as a map service provider, a local search provider, a social network provider, or any other type of Internet service.

In one embodiment, the client devices 108-110 may include a desktop computer 108 in use by a user to conduct Internet searches using the business listing server 104. The desktop computer 108 may transmit one or more search queries to the business listing server 104 and, in response, the business listing server 104 may include one or more business listings in the search results sent to the desktop computer 108. As discussed below, the business listing information provided to the desktop computer 108 may include one or more Uniform Resource Locations (“URLs”) for one or more websites associated with the business listings provided to the desktop computer 108. The user may select one or more of the URLs to visit the websites associated with the business listings. A website URL for a business listing is one of many different types of business listing information that the business listing server 104 may provide, and additional types of business information are discussed further below.

The client device 110 may be a mobile device 110, such as a laptop, a smartphone, a Personal Display Assistant (“PDA”), a tablet computer, or other such mobile device. As with the desktop computer 108, the mobile device 110 may transmit one or more queries to the business listing server 104, such as search queries or navigation queries, and the business listing server 104 may incorporate one or more business listings in the response sent to the mobile device 110. Hence, whether the client devices 106-110 are systems 106 (e.g., Internet search providers, local search providers, social network providers, etc.), desktop computers 108, mobile devices 110 (e.g., laptops, smartphones, PDAs, etc.), the business listing server 104 may be operative to provide one or more business listings to the client devices 106-110 based on a request for the one or more business listings.

In general, a business listing describes business information about a business. A business listing may include may different types of information about the business, such as the business' title (e.g., corporate business name (“Google, Inc.”), informal business name (“Google”), etc.), the business' phone number, a URL for the business, a description of the business, or any other type of information about the business. Each of the types of information may be considered a business listing attribute, and each attribute may have a value. For example, the informal business name may be considered a business listing attribute and the business name “Google” may be considered the business listing attribute value for the informal business name attribute.

When a business listing is requested from the business listing server 104, the business listing server 104 may transmit a response that includes a complete business listing. In this embodiment, the requesting party may parse the business listing to extract a subset of business information for the requesting party's use. For example, an Internet search provider may request a business listing from the business listing server 104 in response to an Internet search query by an end user. When the Internet search provider receives the business listing, the Internet search provider may then transmit the business' title and associated URL to the end user, rather than the complete set of business information that the Internet search provider initially received. Of course, the Internet search provider may provide the complete set of business information to the end user.

In another embodiment, the business listing server 104 may be operative to transmit a select portion of the business listing to a requesting party. Using the Internet search provider example above, the business listing server 104 may receive a request for a business listing title and business listing URL, and based on this request, the business listing server 104 may transmit the business' title and associated URL to the Internet search provider. However, it should be understood that the examples above may also apply where the business listing server 104 communicates with the end user (e.g., client devices 108-110). Hence, the business listing server 104 is flexible and robust enough such that it may provide a complete business listing or a subset of the business listing, depending on the request that the business listing server 104 receives.

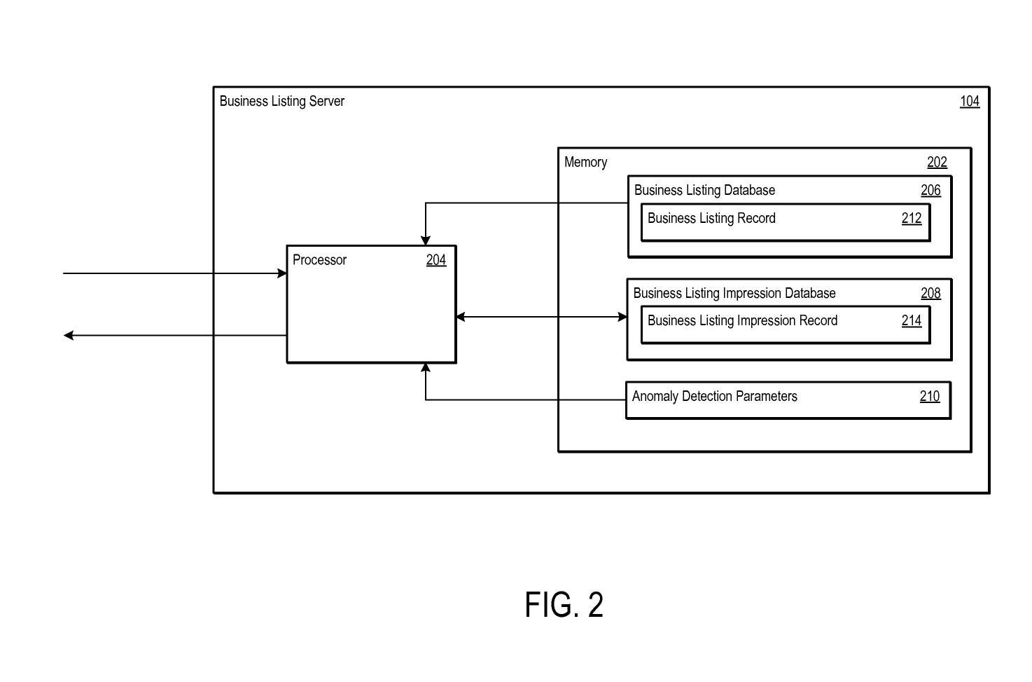

FIG. 2 is one example of the business listing server 104. The business listing server 104 may include a memory a memory 202 in communication with a processor 204. The memory 202 may be operative to store a business listing database 206, a business listing impression database 208, and one or more anomaly detection parameters 210.

The business listing database 206 may store one or more business listing records 212. A business listing record may be store or represent a business listing. A business listing record 212 may store information about the business, such as the business' title, the business' phone number, the description about the business, the business' postal address, the URL for the business' website, or other such business information.

A business listing record 212 may be associated with one or more user accounts. In one embodiment, a user may communicate with the business listing server 104 to establish the business listing record 212. For example, the user may fill out a form, such as an online form, a paper form, or combination thereof, and provide the business listing information that business listing server 104 uses to establish the business listing record 212. Moreover, a user may have established multiple business listings with the business listing server 104. In other words, more than one business listing record 212 may be assigned to a user. In some situations, a user may have established multiple business listings that are fake business listings. In other words, the fake business listings may be for businesses that do not physically exist, but where the phone numbers or homepages associated with the fake business listings are forwarded to a true phone number or true homepage for the business. As discussed below, the business listing server 104 may account for the business listing records 212 assigned to a user in determining whether the business listings that the business listing server 104 provides are potentially false business listings (e.g., business listings that are used to make it appear as though a business is in multiple different locations).

The business listing impression database 208 may store a plurality of business listing impression records 214. A business listing impression record 214 may store an impression value that identifies a number of times a corresponding business listing from the plurality of business listing records 212 was provided for viewing by one or more of the client devices 106-110. Moreover, an impression value may identified the number of times a corresponding business listing was selected by an end user after the business listing was presented to the end user such as when the end user selects URL of the business listing presented in a plurality of search results.

In general, an impression may occur when a business listing is provided to a requesting party (e.g., an Internet search provider, a social network provider, an end user conducting Internet search queries, etc.). This first type of impression may occur when business listing information from a business listing record 212 is presented to a user, such as when the business listing information is presented in a set of search results, in an online advertisement (e.g., banner advertisement, frame advertisement, etc.), or as the result of any other type of request for the business listing information. The business listing server 104 may record each time this first type of impression occurs with a particular business listing.

Moreover, the business listing server 104 may record an impression value of this first type of impression when any part of the business listing is provided to a requesting party. As discussed previously, the business listing server 104 may provide portions of the business listing to a requesting party, such as the business' title and/or business' phone number, and the business listing server 104 may record an impression value each time these portions of the business listing are provided to the requesting party. Hence, the impression value for a business listing record 212 may increase whether the complete business listing is provided or even when a portion of the business listing is provided.

A second type of impression may occur when an end user selects a URL associated with the business listing. For example, when a set of search results are presented to an end user, such as a set of search results presented on the mobile device 110, the business listing server 104 may record an impression when the end user selects the URL associated with the business listing. This second type of impression focuses on whether the user may have found the business listing relevant to the activity of the user. For example, when the user selects the URL associated with the business listing, the business listing server 104 may determine that the user found the business listing helpful or relevant to his or her search queries.

In addition, the business listing server 104 may define when an impression occurs. For example, the business listing server 104 may define that an impression occurs when the business listing information is provided and the end user selects a URL associated with provided business listing information. Other permutations or definitions of an impression are also possible.

Depending on the level of activity for a given business listing, the business listing server 104 may record hundreds, thousands, tens of thousands, or any other number of impressions for a given business listing. In addition, the business listing server 104 may define the granularity at which an impression is recorded. For example, the business listing server 104 may record an impression when the complete set of business listing information is provided from the business listing record 212. As another example, the business listing server 104 may record an impression when any part of the business listing information is provided or selected, and the business listing server 104 may maintain a discrete business listing impression record 214 for that particular portion of the business listing that was provided or selected. Hence, for any given business listing, the business listing server

The business listing server 104 may also maintain one or more impression values for the number of impressions that occurred for a business listing (or portion thereof) over a given time period. For example, the business listing server 104 may maintain an impression value for a business listing for each hour of a day, for each day of the week, for each week of the month, and so forth. Alternatively, the business listing server 104 may maintain a timestamp with each impression value such that the business listing server 104 may retrieve any range of impression values based on a given time. Thus, where each impression value is associated with a timestamp, the business listing server 104 may retrieve the impression values for a business listing that occurred from 9:00 A.M. on Jan. 1, 2011 through 10:00 P.M. on Jan. 10, 2011.

Depending on the granularity in which the business listing server 104 records an impression value, the business listing server 104 may recall the number of impressions a business listing received for any given time period. In addition, because multiple business listings may be established for a common business, the business listing server 104 may be able to recall the total number of impressions a particular business received. In one embodiment, multiple business listings may be established for a common business where the multiple business listings are associated with the same user account.

In another embodiment, a plurality of business listings may be associated with a common business when each of the business listings have the same, or nearly the name, business listing attribute value for a business listing attribute. For example, when a plurality of business listings have the same URL attribute value for the business listing URL attribute, the plurality of business listings may be identified as being associated with a common business. As another example, the plurality of business listings may be associated with a common business when each of the plurality of business listings have the same, or nearly the same, phone number for a business listing phone number attribute. Moreover, as the number of identical, or nearly identical, business listing attribute values increase, the greater the likelihood that the plurality of business listings are identified as being associated with a common business. Thus, business listings that have three business listing attribute values in common are more likely to be identified as being associated with a common business than business listings with less than three business listing attribute values in common.

To detect whether a common business has established potentially false business listings, the business listing server 104 may maintain a set of anomaly detection parameters 210. The anomaly detection parameters 210 may include parameters for the processor 204 to determine an anomaly detection threshold, which may then be used to determine whether a set of impressions over a given time period indicate whether a common business has potentially false business listings.

In one embodiment, the processor 204 determines the anomaly detection threshold based on statistical analysis, such as through the calculation of a standard deviation for a given set of impressions. To this end, the anomaly detection parameters 210 may include a time period parameter that instructs the processor 204 to retrieve impression values for a selected business listing over a given time period, such as one or more days, one or more months, etc.; a time segment parameter that instructs the processor 204 as to the granularity of impression values to use in determining the anomaly detection threshold (e.g., impressions per minute, impressions per hour, impressions per day, etc.); and a threshold parameter that instructs the processor 204 when a given set of impression values should indicate that potentially false business listings are being provided, such as one standard deviation above the average number of impressions, two standard deviations above the average number of impressions, or other such thresholds.

In addition, where the number of impressions for one or more business listings associated with the same user are in question, the processor 204 may determine the anomaly detection threshold based on impression values for the one or more business listings. The anomaly detection parameters 210 may include a business listing parameter that instructs the processor 204 which business listings (or portions thereof) to consider when determining the anomaly detection threshold. Hence, the business listing server 104 may detect multiple potentially false business listings where one or more business listings are associated with the same user.

After determining the anomaly detection threshold, which may be one standard deviation above the average number of impressions, two standard deviations above the average number of impressions, etc., the processor 204 may then compare the anomaly detection threshold with a set of impression values from a second time period. This second time period may be one or more time segments from the first time period that the processor 204 used to determine the anomaly detection threshold, a different time period than the first time period, or combinations thereof. For example, the anomaly detection threshold may be based on the number of impressions per day that a business listing, or a common business for multiple business listings, received during January 2011 (the first time period), and this anomaly detection threshold may be compared against the number of impressions the business listing, or a common business for multiple business listings, received on a day in February 2011 (the second time period). Of course, using the above example, the second time period may also be a day from January 2011.

In one embodiment, when the impression value for the common business from a second time period exceeds the anomaly detection threshold, the processor 204 may identify that the common business is associated with potentially false business listings. However, as some anomalies are to be expected, the processor 204 may request verification that the impression value from the second time period is an anomaly. For example, the processor 204 may request a moderator or other system to confirm that the business listings associated with the recorded impression values are false business listings. In another embodiment, the processor 204 may not request verification, but may assume that the business listings provided during the second time period were, in fact, false business listings.

In yet another embodiment, the business listing server 104 may maintain a record of one or more anomaly detection thresholds for one or more time periods. For example, the business listing server 104 may maintain the anomaly detection threshold for each week in a given month. In this manner, the business listing server 104 may compare the anomaly detection thresholds of a first month with the anomaly detection thresholds of a second month to determine whether an impression value for a given business listing, or a common business for multiple business listings, is anomalous.

For example, suppose that the business listing server 104 maintains an anomaly detection threshold for a business listing for each week in the months of January and February, and that the anomaly detection thresholds for each week in February are lower than the anomaly detection thresholds for each week in January. After initially comparing an impression value for a business listing, or for a common business associated with multiple business listings, against the anomaly detection thresholds for February, the business listing server 104 may then compare the impression value against the anomaly detection thresholds for January. In this manner, the business listing server 104 may avoid falsely identifying an impression value as an anomaly where the impression value exceeds the anomaly detection thresholds for February, but not the anomaly detection thresholds for January. Hence, the business listing server 104 may include several layers of safeguards to ensure that one or more impression values for a given business are the result of providing “real” business listings, and not from providing potentially false business listings.

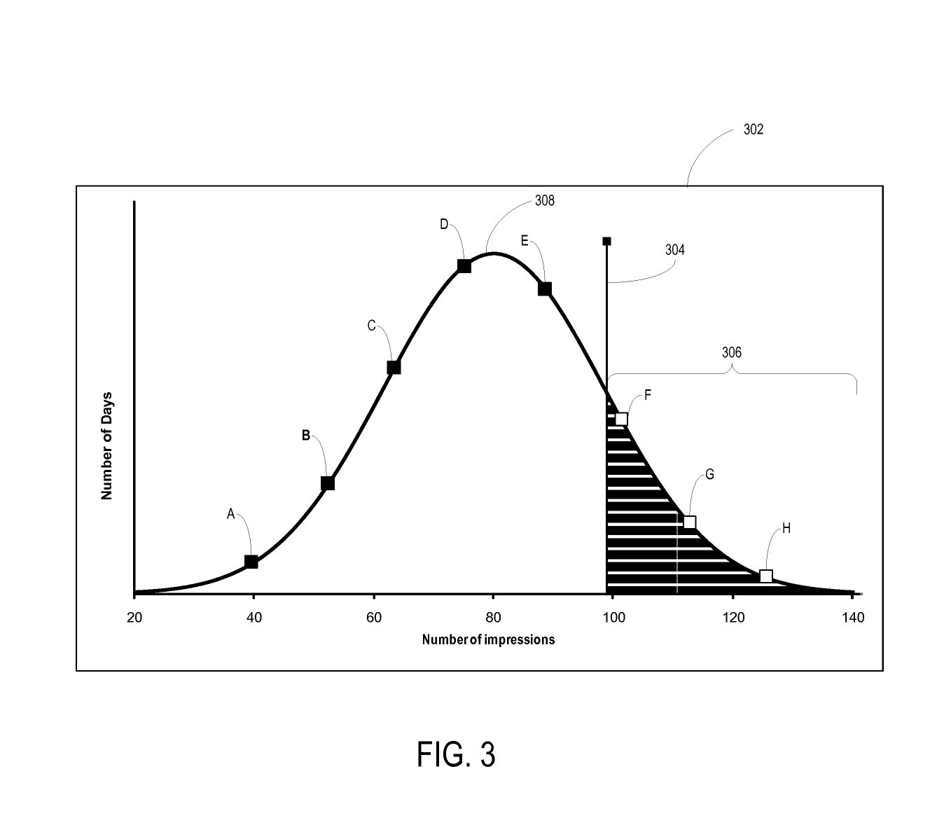

FIG. 3 illustrates one example of determining an anomaly detection threshold according to aspects of the invention. FIG. 3 illustrates a bell curve-shaped graph 302 having exemplary data points A-H plotted along a distribution curve 308 for a given time period. The data points A-H may represent the number of time segments, such as the number of days, that received a number of impressions over the given time period. The bell curve 308 illustrates the distribution of the data points A-H, and that there a few days (data points A-C) receiving a lower number of impressions, a few days (data points D-E) receiving an average number of impressions, and a few days (data points F-H) receiving a higher than average number of impressions.

Based on the anomaly detection parameters 210, the processor 204 may determine the standard deviation for the data points A-H, and then establish an anomaly detection threshold based on this standard deviation. Of course, depending on the anomaly detection parameters 210, the anomaly detection threshold may be two or more standard deviations above average. In FIG. 3, line 304 illustrates one example of the anomaly detection threshold and is approximately one standard deviation above the average number of impressions. Accordingly, the processor 204 may identify the days corresponding to data points F-H (segment 306), as receiving a number of impressions that exceed the anomaly detection threshold 304. Hence, the processor 204 may identify the impressions that were received for the segment 306 as potentially impressions resulting from providing potentially false business listings.

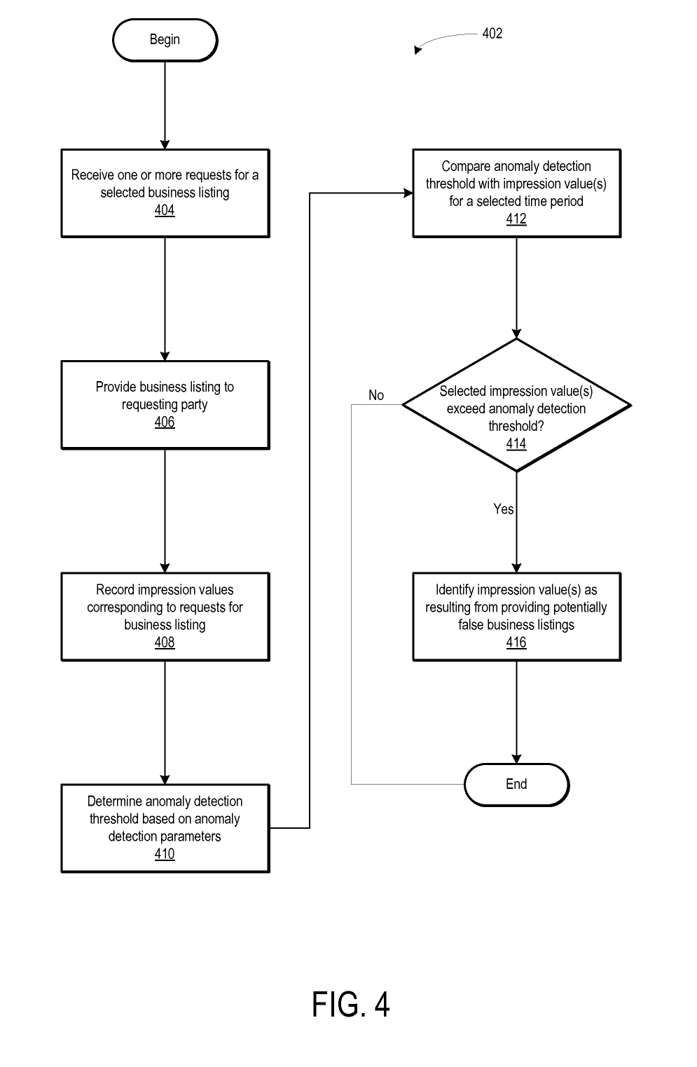

FIG. 4 illustrates one example of logic flow 402 for detecting potentially false business listings according to aspects of the invention. Initially, the business listing server 104 may receive a request for a business listing stored in the business listing database 206 (Block 404). The business listing server 104 may then provide the requested business listing to the party or entity (e.g., an Internet search provider, an end user, etc.) requesting the business listing (Block 406). As discussed above, the business listing server 104 may maintain an impression value each time the business listing is requested (Block 408). Moreover, the business listing server 104 may maintain an impression value for each portion of the business listing, such as the number of times the business listing title was requested, the number of times the business listing URL was requested, and other such impression values. As a common business may have multiple business listings, the business listing server 104 may maintain a common set of impression values derived or based on the impression values for the associated business listings.

The processor 204 may then determine an anomaly detection threshold based on the anomaly detection parameters 210 (Block 410). As discussed previously, the anomaly detection parameters 210 may have parameters such as a time period parameter, a time segment parameter, a business listing parameter, and other such parameters that instruct the processor 204 how to determine the anomaly detection threshold. The processor 204 may also consider the number of impressions that related business listings (i.e., business listings having a common user) have received in determining the anomaly detection threshold. For example, the processor 204 may consider the number of impressions that more than one business listing has received during a given time period. In one embodiment, the anomaly detection threshold may be one or more standard deviations above the average number of impressions a business listing receives for a given time period. The anomaly detection threshold may also be one or more standard deviations above the average number of impressions a common business receives where the common business is associated with multiple business listings.

The processor 204 may then compare the anomaly detection threshold with the number of impressions a business listing received, including portions thereof, for a second time period (Block 412). Alternatively, or in addition, the processor 204 may compare the anomaly detection threshold with the number of impressions a common business received for the second time period. As mentioned above, the second time period may be one or more time segments from the time period used to determine the anomaly detection threshold, a different time period, or combinations thereof. The processor 204 may then decide whether the number of impressions for the business listing (or common business) during the second time period exceeds the anomaly detection threshold (Block 414). Should the number of impressions exceed the anomaly detection threshold, the processor 204 may identify that the number of impressions may be the result of providing potentially false business listings (Block 416).

In an alternative embodiment, the processor 204 may then compare the impressions identified as potentially false impressions with other anomaly detection thresholds, such as anomaly detection thresholds from similar time periods, to determine whether the potentially false impressions are, in fact, false impressions. The processor 204 may further request verification by a moderator or other system that the potentially false business listings are, in fact, false business listings.

In this manner, the business listing server 104 facilitates an expeditious identification of potentially business listings that may have been established by a common business owner. By leveraging an anomaly detection threshold (e.g., by calculating a standard deviation over a given period of time), the business listing server 104 may sift through the thousands of impressions that a business listing receives to identify which impressions may have resulted from providing false business listings. In addition, because the business listing server 104 may account for impressions received across business listings assigned to a common user, the business listing server 104 is in a position to identify whether a user is generating false business listings to increase the relevance or importance of the user's business. Hence, the embodiments of the business listing server 104 serve to ensure that the impressions a business listing receives are “real” impressions, and that no one business listing is unduly elevated above any other business listing. When potentially false business listings are identified as false business listings, the false business listings may be removed from the business listing server 104 or may be demoted in their relevance such that they no longer appear in search results.

The business listing server 104 described above may be implemented in a single system or partitioned across multiple systems. In addition, the memory 202 may be distributed across many different types of computer-readable media. The memory 202 may include random access memory (“RAM”), read-only memory (“ROM”), hard disks, floppy disks, CD-ROMs, flash memory or other types of computer memory.

The business listing database 206, the business listing impression database 208, and the anomaly detection parameters 210 may be implemented in a combination of software and hardware. For example, the anomaly detection parameters 210 may be implemented in a computer programming language, such as C# or Java, or any other computer programming language now known or later developed. The anomaly detection parameters 210 may also be implemented in a computer scripting language, such as JavaScript, PHP, ASP, or any other computer scripting language now known or later developed. Furthermore, the anomaly detection parameters 210 may be implemented using a combination of computer programming languages and computer scripting languages.

In addition, the business listing server 104 may be implemented with additional, different, or fewer components. As one example, the processor 204 and any other logic or component may be implemented with a microprocessor, a microcontroller, a DSP, an application specific integrated circuit (ASIC), discrete analog or digital circuitry, or a combination of other types of circuits or logic. The business listing database 206, the business listing impression database 208, and the anomaly detection parameters 210 may be distributed among multiple components, such as among multiple processors and memories, optionally including multiple distributed processing systems.

Logic, such as programs, may be combined or split among multiple programs, distributed across several memories and processors, and may be implemented in or as a function library, such as a dynamic link library (DLL) or other shared library. The DLL, for example, may store code that implements functionality for a specific module as noted above. As another example, the DLL may itself provide all or some of the functionality of the system.

The business listing database 206 and the business listing impression database 208 may be stored as a collection of data. For instance, although the business listing database 206 and the business listing impression database 208 are not limited by any particular data structure, the business listing database 206 and the business listing impression database 208 may be stored in computer registers, as relational databases, flat files, or any other type of database now known or later developed.

The network 112 may be implemented as any combination of networks. As examples, the network 112 may be a Wide Area Network (“WAN”), such as the Internet; a Local Area Network (“LAN”); a Personal Area Network (“PAN”), or a combination of WANs, LANs, and PANs. Moreover, the network 112 may involve the use of one or more wired protocols, such as the Simple Object Access Protocol (“SOAP”); wireless protocols, such as 802.11a/b/g/n, Bluetooth, or WiMAX; transport protocols, such as TCP or UDP; an Internet layer protocol, such as IP; application-level protocols, such as HTTP, a combination of any of the aforementioned protocols, or any other type of network protocol now known or later developed.

Interfaces between and within the business listing server 104 may be implemented using one or more interfaces, such as Web Services, SOAP, or Enterprise Service Bus interfaces. Other examples of interfaces include message passing, such as publish/subscribe messaging, shared memory, and remote procedure calls.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention as defined by the appended claims. Furthermore, while certain operations and functions are shown in a specific order, they may be performed in a different order unless it is expressly stated otherwise.

1. A system for detecting potentially false business listings, the system comprising:
one or more processors operative to:
determine an anomaly detection threshold for a common business using a plurality of impression values for a plurality of business listings associated with the common business from a first time period in which one or more business listings including business information for the common business were requested, the plurality of impression values from the first time period each include a number of times a corresponding business listing was selected by a user after being presented to the user for viewing during the first time period;
compare the anomaly detection threshold with one or more impression values from a second time period in which one or more business listings for the common business were requested, the plurality of impression values from the second time period each include a number of times a corresponding business listing was selected by a user after being presented to the user for viewing during the second time period; and
when the one or more impression values from the second time period exceeds the anomaly detection threshold, identify the common business as having potentially false business listings in the plurality of business listings.

2. The system of claim 1, wherein the one or more processors are further operative to determine the anomaly detection threshold as two standard deviations above an average number of impressions for the plurality of business listings.

3. The system of claim 1, wherein the one or more processors are further operative to provide the one or more business listings to a client device when the one or more processors receive a request for the one or more business listings from the client device.

4. The system of claim 1, where the plurality of business listings are associated with the common business when each of the business listings of the plurality of business listings have the substantial same business listing attribute value for a business listing attribute.

5. The system of claim 1, wherein a business listing of the plurality of business listings comprises a business listing phone number and an impression value from the one or more impression values from the second time period is based on a number of times the business listing phone number was provided to a client device during the second time period.

6. The system of claim 1, wherein a business listing of the plurality of business listings is associated with a web site and an impression value from the one or more impression values from the second time period is based on a number of times the web site associated with the business listing was provided to a client device client device during the second time period.

7. The system of claim 1, wherein a business listing of the plurality of business listings comprises a business listing title and an impression value from the one or more impression values from the second time period is based on a number of times the business listing title was provided to a client device during the second time period.

8. The system of claim 1, wherein:
a business listing of the plurality of business listings comprises a business listing title and a business listing phone number, the business listing being associated with a web site; and
an impression value from the one or more impression values from the second time period is based on the number of times any of the business listing title, the business listing phone number, and the web site was provided to a client device.

9. The system of claim 1, wherein:
the first time period is segmented into one or more time segments comprising one or more days; and
an impression value from the one or more impression values from the first time period is based on the number of times the business listing was provided to a client device during a selected time segment from the first time period.

10. The system of claim 1, wherein the first time period is a longer time period than the second time period.

11. The system of claim 1, wherein the first time period is segmented into one or more time segments, and the second time period comprises a selected time segment from the first time period.

12. The system of claim 1, wherein the first time period is segmented into one or more time segments, and the anomaly detection threshold is determined from a standard deviation of selected impression values from a selected plurality of time segments from the first time period.

13. The system of claim 1, wherein the one or more processors are further operative to request verification that the identified common business has the one or more potentially false business listings.

14. A method for detecting potentially false business listings, the method comprising:
determine an anomaly detection threshold for a common business using a plurality of impression values for a plurality of business listings associated with the common business from a first time period in which one or more business listings including business information for the common business were requested, the plurality of impression values from the first time period each include a number of times a corresponding business listing was selected by a user after being presented to the user for viewing during the first time period;
comparing, by the one or more processors, the anomaly detection threshold with one or more impression values from a second time period in which one or more business listings for the common business were requested, the plurality of impression values from the second time period include a number of times a corresponding business listing was selected by a user after being presented to the user for viewing during the second time period; and
when the one or more impression values from the second time period exceeds the anomaly detection threshold, identifying, by the one or more processors, the common business as having potentially false business

15. The method of claim 14, further comprising determining the anomaly detection threshold as two standard deviations above an average number of impressions for the plurality of business listings.

16. The method of claim 14, further comprising providing the one or more business listings to a client device when a request is received for the one or more business listings from the client device.

17. The method of claim 14, where the plurality of business listings are associated with the common business when each of the business listings of the plurality of business listings have the substantial same business listing attribute value for a business listing attribute.

18. The method of claim 14, wherein a business listing of the plurality of business listings comprises a business listing phone number and an impression value from the one or more impression values from the second time period is based on a number of times the business listing phone number was provided to a client device during the second time period.

19. The method of claim 14, wherein a business listing of the plurality of business listings is associated with a web site and an impression value from the one or more impression values from the second time period is based on a number of times the web site associated with the business listing was provided to a client device client device during the second time period.

20. The method of claim 14, wherein a business listing of the plurality of business listings comprises a business listing title and an impression value from the one or more impression values from the second time period is based on a number of times the business listing title was provided to a client device during the second time period.

21. The method of claim 14, wherein:
a business listing of the plurality of business listings comprises a business listing title and a business listing phone number, the business listing being associated with a web site; and
an impression value from the one or more impression values from the second time period is based on the number of times any of the business listing title, the business listing phone number, and the web site was provided to a client device.

22. The method of claim 14, wherein:
the first time period is segmented into one or more time segments comprising one or more days; and
an impression value from the one or more impression values from the first time period is based on the number of times the business listing was provided to a client device during a selected time segment from the first time period.

23. The method of claim 14, wherein the first time period is a longer time period than the second time period.

24. The method of claim 14, wherein the first time period is segmented into one or more time segments, and the second time period comprises a selected time segment from the first time period.

25. The method of claim 14, wherein the first time period is segmented into one or more time segments, and the anomaly detection threshold is determined from a standard deviation of selected impression values from a selected plurality of time segments from the first time period.

26. The method of claim 14, further comprising requesting verification that the identified common business has the one or more potentially false business listings.

27. (canceled)

28. The system of claim 1, wherein the one or more processors are further configured to at least one impression value from the plurality of impression values during the first time period is based on a number of times a corresponding business listing was selected by a user after being presented to the user for viewing.
